(19) United States
(12) Patent Application Publication
(10) Pub. No.: US 2010/0117799 A1
(43) Pub. Date: May 13, 2010

(54) SECURE PERSONAL INFORMATION AND NOTIFICATION NETWORK FOR ELECTRONIC HEALTH RECORDS SYSTEMS

(76) Inventors: Douglas Eugene Dormer, Ann Arbor, MI (US); Bradford Hyde Chick, Ann Arbor, MI (US)

Correspondence Address: JELIC PATENT SERVICES, LLC, 2922 MARSHALL ST, ANN ARBOR, MI, 48108, US

(21) Appl. No.: 12/463,376

(22) Filed: May 8, 2009

Related U.S. Application Data
(60) Provisional application No. 61/053,120, filed on May 14, 2008.

(51) Int. Cl. H04Q 5/22; G06F 17/30; G06F 15/16; H04M 1/64

(52) U.S. Cl. 340/10.1; 707/609; 709/206; 379/67.1; 707/802; 707/769; 709/207; 707/E17.005; 707/E17.044

(57) ABSTRACT

The present invention provides a secure personal information and notification network for electronic health records systems. A client's personal health record may be entered into a secure database and updated in a number of different ways. Information required to identify the client and access the personal health record is carried on or near the client. Upon finding the information required to identify the client, authorized personnel may access the personal health records during an emergency. In addition, a predetermined individual or individuals will receive automated notification of a client emergency.

### CROSS REFERENCE TO RELATED APPLICATIONS

This application claims the benefit of U.S. Provisional Application 61/053,120 filed May 14, 2008. The content of this prior patent application is incorporated by reference.

### BACKGROUND OF THE INVENTION

For many reasons, the healthcare industry is moving from paper-based record keeping systems to electronic medical records systems. These include but are not limited to provider controlled electronic medical records, patient or consumer controlled personal health records, and electronic medical records stored on a health information exchange which may be accessed by multiple healthcare providers as well as the consumer and his or her guardian. These may also exist in varying combinations of systems and may include some level of access to selected information by the public (such as emergency medical information).

### BRIEF SUMMARY OF THE INVENTION

The present invention provides a secure personal information and notification network for electronic health records systems. A client's personal health record may be entered into a secure database and updated in a number of different ways. Information required to identify the client and access the personal health record is carried on or near the client. Upon finding the information required to identify the client, authorized personnel may access the personal health records during an emergency. In addition, a predetermined individual or individuals will receive notification of a client emergency.

The information required to identify the client may be contained on a Radio Frequency IDentification (RFID) capable device. Authorized emergency personnel may interrogate the RFID capable device to determine critical client information. Additional client information may be available and accessed from the secure database.

There are a plurality of methods whereby the predetermined individual or individuals may receive the notification of a client emergency. One example is that an e-mail message may be sent. A second example is that a text message may be sent. A third example is that an automated voice-message may be sent. These examples are not meant to be limiting and other communication methods may be used to notify the predetermined individual or individuals.

### BRIEF DESCRIPTION OF THE DRAWINGS

FIG. 1 shows a block diagram giving one potential embodiment of the present invention.

### DETAILED DESCRIPTION OF THE INVENTION

The security and privacy of important personal health information is paramount. Breach of this privacy can cause significant harm to consumers as well as healthcare providers. Policies reflecting appropriate levels of expectation for security and privacy are evolving. Standards, such as HIPAA or other state security or privacy regulations are limited in applicability and scope, and are sometimes inconsistent with each other, all of which make the assurance of security and privacy very difficult.

While standards may be developed that will address some of these issues, and security technologies may make it more difficult to gain unauthorized access to information, unauthorized access to personal health information is impossible to stop completely. Breaches of one sort or another will occur.

This concern over the security and privacy of electronic medical records is often cited as one of the primary reasons for the slow adoption of electronic medical records systems generally, at some cost not only to the individual but for society, from both economic and a public health perspectives.

Therefore, to address at least a subset of breaches when unauthorized people gain access to personal health information, a system is needed whereby the people who are most concerned by the privacy of said personal health information will be automatically notified anytime said personal health information is accessed, viewed or changed in order that they may determine if there is a breach and to mitigate the damage at the earliest opportunity.

Separately, but leading to substantially the same conclusion, the population is aging and more people live with chronic medical conditions such as diabetes, Alzheimer's disease, AIDS/HIV, hypertension and other chronic conditions. At the same time, we live in a mobile society where extended families are spread far apart. Children are concerned about aging parents, while parents are concerned about their children.

Despite the proliferation of communication tools such as cell phones, e-mail, instant messaging, etc, people are concerned. If a loved one suffers a medical emergency, will they know? For example, if a loved one is unconscious or unable to communicate and is brought to an emergency room or other medical facility for treatment, neither the staff nor the patient may know who the patient is or how to contact family or guardians.

In such situations, the medical staff or caregivers may look to the patient's electronic medical record for information about medications, allergies, medical conditions or emergency contacts. Still, family or guardians may not know that their loved one is receiving medical attention. It is not enough to rely upon caregivers to assign someone the task of tracking down family or guardians even if some contact information is available. Lack of knowledge at a critical moment can exacerbate an already difficult situation. Knowing that a medical emergency is in progress, and knowing that you will know, provides peace of mind for both the patient and the family and guardians.

Again, a system is needed whereby the family and guardians, the people who are responsible for said personal health information as well as for the patient, will be automatically notified anytime personal health information is accessed, viewed, or changed.

One aspect of effectively deploying electronic medical records and driving customer adoption is to incorporate electronic medical records beyond the strict health care environment of hospitals, clinics, physicians' offices, etc. The preferred approach is to bring electronic medical records closer in alignment with people's everyday lives.

In this respect, we note that RFID is being deployed in both medical and non-medical scenarios, but nowhere are these various uses combined or merged into a comprehensive solution.

For example, over 6.5 million people participate each year in participatory sporting events such as road races. These typically range from 5 kilometers to a marathon—26.2 miles. It is not uncommon for major races, particularly marathons, to include more than 20,000 participants.

Timing is obviously important to these participants and organizers. The vast majority of these events rely on some form of RFID technology to record the time as the participant passes check points including the starting line and the finish line.

One thing is certain: when 20,000 people set out to run 26.2 miles, not all are going to finish. Some will be injured or fall ill. Some may die. Race organizers are usually required to provide some level of emergency medical services to respond to such emergencies.

As a part of the registration process, participants may be asked to enter on a form information about medications, allergies, and chronic medical conditions. No system exists to ensure that this information will be immediately available anywhere along course of the event.

At the same time, RFID is used in the medical setting to track patients through the healthcare system and to track assets. According to one approved patent, a complete medical history may be stored on a medical device that is accessed by a system that incorporates RFID.

These two uses of RFID technology have thus far been completely separate and distinct. To the best of our knowledge, in no instance has an existing RFID solution deployed in a sporting event been linked to and integrated with an electronic medical record system for the purpose of identifying and authenticating the patient to provide access to personal health information.

Therefore, to address the objective of providing critical health information at the time and place it is most important, a system is needed that will allow the same technologies that are used in sporting events, including but not limited to RFID, to be integrated with electronic medical records systems to ensure that critical information is available when and where it is most valuable to save lives.

The situation described for races and participatory events applies and includes any other group setting. Examples without limitation include cruises, conferences, youth athletics programs, school identification cards, and any other group or organizational setting. Additional examples include individuals who are associated with an organization. Possible examples of an organization are an insurance provider, a home care provider, a nursing home, a social club, a patient advocacy group, or any other group or organization.

Prior art draws from many patents, publications, and established technologies which have never been used in this novel combination for these unobvious yet terribly important purposes.

Among the prior art references, we look to the “Portable health care history information system” by Logan, U.S. Pat. No. 7,039,628 as well as patents, patent applications, or prior art as published by Microsoft in connection with its HealthVault personal health record platform, MyMedicalRecords.com, Google, and others. Nowhere do we find any reference to an automated notification solution such as that described herein.

Similarly, there are extensive prior art references relating to the various uses of RFID. However, nowhere do we find reference to a system, process, or method whereby RFID used for non-medical purposes is integrated into an electronic medical system. Given the proliferation of RFID in so many areas, the absence of the cross-over implementation provides strong evidence of the novel and unobvious nature of this new combination and new use invention.

It is an object of the present invention to provide a compensating control which compliments other security and privacy measures. The compensating control is designed to mitigate the further disclosure of confidential information by informing consumers, guardians, or healthcare providers that someone's personal health information has been accessed. Then, the recipient can determine if such access was authorized and take timely action as appropriate. The advantage is that in the event preventive security measures fail, there will be a notification that will inform the responsible party. This allows the responsible party to take appropriate action in a timely manner to mitigate the damage caused by the breach.

It is an object of the present invention to inform family, guardians, or healthcare providers that a patient is receiving medical attention at the earliest possible moment. To illustrate through one scenario under one embodiment, an adult child may be responsible for a parent who suffers from Alzheimer's disease. As too often happens, the parent may wander off, become confused and frightened, and end up in the emergency room where hospital staff must determine, among other things, who is this person? Who is his or her guardian? Are the present symptoms a manifestation of some recent onset condition that needs immediate treatment, or just another day in the life of someone suffering from Alzheimer's disease?

Were the care givers view or otherwise access the patient's electronic medical record to learn important information, the present invention would automatically generate a message to the pre-designated people informing them who is looking at the information and how to contact the care giver. In this way, this present invention will provide improved health care by bringing the guardian into the discussion at the earliest moment. In addition, the present invention provides peace of mind for both the child and the parent, since the parent will not be alone in an emergency.

It is an object of the present invention to mitigate the public's concern over security and privacy by increasing the likelihood that if personal health information is compromised, at least the pre-designated people will know, and will have an opportunity to act. This will have an advantage not just at the level of the individual user of the electronic medical records system, but by providing a higher level of confidence, it will increase overall confidence in such systems, leading to higher usage rates across the population, thus expanding the benefit of electronic medical records beyond what is capable under prior art.

It is an object of the present invention to increase the value of electronic medical record systems among the population by providing a new feature. The feature helps assure that if a loved one receives medical attention, they will not be alone because family and guardians are not aware. This will have the advantage not just at the individual level, but will also increase overall usage as the public comes to desire this important benefit.

It is an objective of the present invention to extend the use and benefit of electronic medical records beyond the purely medical setting and into the activities that are a part of how people live their lives. The advantage will be to ensure that critical medical information is available at the time and place it is most needed.

It is an objective of the present invention to increase the usage of electronic medical records among community of health care providers as they see the increased benefits they can provide to their consumers and patients with little burden or risk.

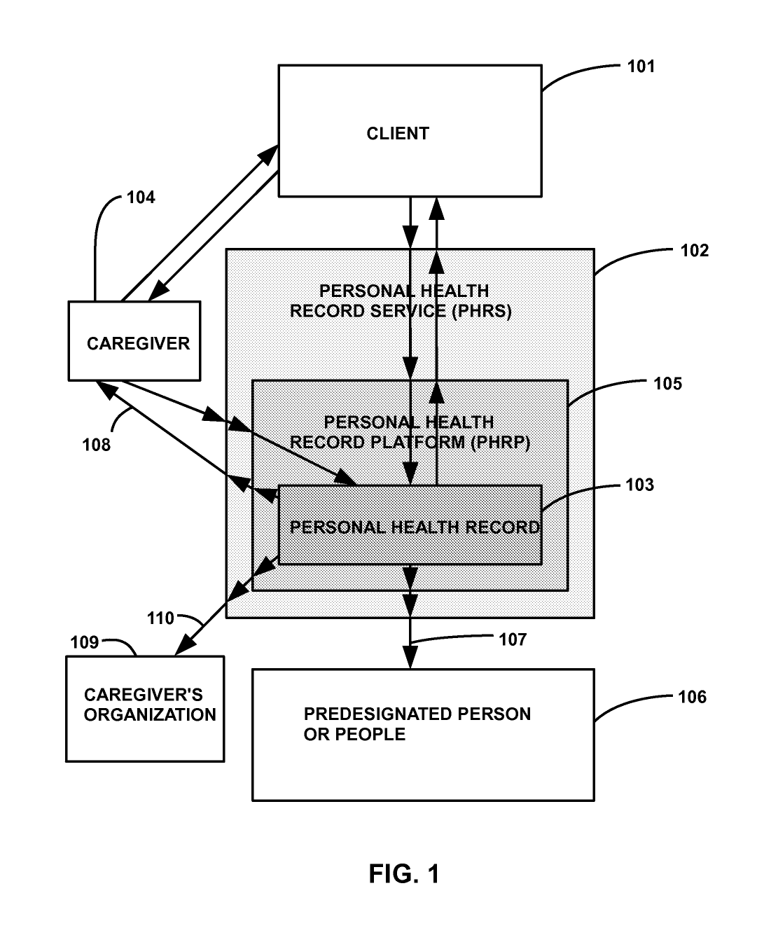

FIG. 1 shows a block diagram giving one potential embodiment of the present invention. In this embodiment, a client 101 could subscribe to a personal health record service (PHRS) 102. The client 101 may also own and control the information in a personal health record 103, which is located in a personal health record platform (PHRP) 105. The PHRS 102 may be a separate service that integrates with the PHRP 105, or it may be an integral part of the PHRP 105. Healthcare providers, such as emergency medical services or even helpful members of the public, are granted access to some or all of the personal health information through the PHRS 102.

Upon encountering a client 101 who is unconscious or otherwise unable to answer questions, the caregiver 104 determines that the patient has some form of identification or device such as a token, bracelet, ID card, or other device that indicates how the caregiver can gain access to personal health information. The caregiver 104 then has some mechanism or process by which he or she can log into the on-line personal health record system 105 and access the personal health record 103. The caregiver 104 would be required to enter some amount of information, possibly including name, organization (if affiliated with one), telephone number, e-mail address, or physical address. The caregiver 104 would also enter the identifying information for the client 101. (In other embodiments, this process might be accomplished through other means, such as a method or process using radio frequency identification or other existing or new technologies to authenticate the patient.) Either the PHRP 105 or the PHRS 102 would record the information used to authenticate or identify the caregiver, including the fields described above. Then, either the PHRP 105 or the PHRS 102 would verify that the information presented by the care giver passes certain tests such as completeness if for a new user, or user name and password confirmation if for a recognized user. The system would also confirm that the client's 101 identifying number is valid, and based on configurable parameters in the client's profile, would transmit or otherwise present the caregiver 104 with certain pre-determined information about the client, possibly including medications, allergies, medical conditions, emergency contacts and other information. The PHRP 105 would record the time and content of the information transmitted or presented to the caregiver 104.

Based on pre-configured profile settings, the PHRP 105 or the PHRS 102 would create and transmit a message 107 to a pre-designated person or people 106. In this embodiment, the message 107 might simply indicate that the client's 101 personal health information has been viewed, along with contact information about how to contact the viewing caregiver 104.

The message 107 could be sent by e-mail, text message to a mobile phone, or by voice message. Other embodiments may include other or additional message delivery methods, both existing and which may be developed over time.

The message 107 would contain information about the caregiver 104 and how to contact the caregiver 104. In other embodiments, the message 107 could simply be a notification that another message exists in another system, such as an on-line system that provides a higher level of security. Examples of higher level security include, but are not limited to, multi-factor authentication or bi-directional encryption/decryption.

The notification process is complete upon the transmission of the message 107. In other embodiments, the notification process could require a positive response, such as a return message or a logon to a secure on-line portal, to confirm that the message 107 has been delivered. In this type of embodiment, a mechanism or process could be included that would re-send the message 107, possibly with a different message, if the positive confirmation is not received in a prescribed time.

Selected information 108 may be transmitted to the caregiver 104 or his/her organization 109 to facilitate treatment or such other processes as billing and payment, if such arrangements have been previously established.

A second possible embodiment is to extend the concept of the present invention into other activities such as races, sporting events, cruises, conventions, schools, or other organizations or groups that use RFID or any other technology that accomplishes a similar function to identify or authenticate a person. In this scenario, the steps are essentially the same as those described in the above embodiment with the following variations (presented as illustrations, not as limiting variations).

A first possible variation is a system, method, or process where by a person who signs up for a group membership or to participate in a function can indicate that he or she desires to have his or her electronic medical records made available in the event of an emergency. Said system, method, or process to include the ability to either create a new personal health profile or to identify and link to an existing set of health records.

A second possible variation is a system, method, or process whereby emergency medical staff will be able to read or scan RFID transponders deployed in various form factors such as the ChampionChip and ChronoTrack devices used in races or any other form factor, and which will then decrypt that information. In this embodiment, the preferred configuration is a hand held computer that contains an RFID reader (card), along with appropriate software to accomplish this task. (As used herein, a cell phone is one form of such computer.) Said hand held computer will also have wireless access to the Internet. (The method of accessing the Internet is not central to this invention. Other communication channels, such as wired connections to the Internet are within the scope of this invention.)

A third possible variation is a system, method, or process whereby the information would be decrypted (if encrypted) and passed through and integrated with the electronic medical records system. Beyond these variations, this embodiment follows the process flow described above, including variations.

The above embodiments contemplate only one arrangement and set of conditions where the present invention may apply. Other embodiments can be contemplated including without limitation an electronic health records system controlled by a hospital, physician, laboratory, pharmacy, or other health care provider including home care delivery and similar services. In these embodiments, the party responsible for the security and privacy of the information, as well as its use in general, might be the healthcare provider through one or more administrators and users. In such embodiments, the events which might trigger a notification might be quite broad and different than those contemplated in the above preferred embodiments, but which are included nonetheless within the scope of the present invention. Similarly, notification might take other forms, and include other parties than those contemplated by the above embodiments, which would also be within the scope of these present inventions.

While these present invention has been described herein with reference to an embodiment and various alternatives thereto, it should be apparent that the invention is not limited to such embodiments. Rather, many variations would be apparent to persons of skill in the art without departing from the scope and spirit of the invention, as defined herein and in the claims.

1. A method for providing a secure personal information and notification network for medical uses, the method comprising:
storing a client's medical records in an electronic database wherein the electronic database is capable of generating an audit history of the client's medical records upon request, enabling the client to update the medical records in the electronic database, enabling the client to update the medical records in the electronic database, and notifying the client when the client's medical records have a change of status;
creating an identification device that the client can carry on or near himself or herself;
designating a receiving person or persons to receive an emergency medical message;
providing the stored personal medical records when an authorized health professional interrogates the identification device;
sending the emergency medical message to the designated receiving person or persons upon interrogation of the identification device; and
resending the emergency medical message to the designated receiving person or persons if the message has not been properly acknowledged.

2. The method of claim 1, wherein the identification device comprises a form which is capable of identifying and authenticating via an RFID signal.

3. The method of claim 2, wherein the change of status occurs every time that the client's medical records are accessed.

4. The method of claim 2, wherein the change of status occurs every time that the client's medical records are changed.

5. The method of claim 2, wherein the change of status occurs every time that the client's medical records are accessed by a subset of possible viewers.

6. The method of claim 3, wherein the emergency medical message consists of an e-mail.

7. The method of claim 3, wherein the emergency medical message consists of a voice message.

8. The method of claim 3, wherein the emergency medical message consists of a text message to a phone.

9. The method of claim 4, wherein the emergency medical message consists of an e-mail.

10. The method of claim 4, wherein the emergency medical message consists of a voice message.

11. The method of claim 4, wherein the emergency medical message consists of a text message to a phone.

12. The method of claim 5, wherein the emergency medical message consists of an e-mail.

13. The method of claim 5, wherein the emergency medical message consists of a voice message.

14. The method of claim 5, wherein the emergency medical message consists of a text message to a phone.
